(19) United States
(12) Patent Application Publication
(10) Pub. No.: US 2006/0128329 A1
(43) Pub. Date: Jun. 15, 2006

(54) Method and system for receiver front end (RFE) architecture supporting broadcast utilizing a fractional N synthesizer for European, world and US wireless bands

(76) Inventor: Pieter Van Rooyen, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 11/010,524

(22) Filed: Dec. 13, 2004

(51) Int. Cl. H04B 1/18; H04M 1/00

(52) U.S. Cl. 455/180.2; 455/552.1

(57) ABSTRACT

A system for communicating information via a plurality of different networks comprises a mobile terminal comprising a mixer and an oscillator coupled to the mixer. The mobile terminal may comprise a fractional N synthesizer coupled to the mixer. The mixer is adapted to mix, within the mobile terminal, received cellular RF signals and received VHF/UHF broadcast RF signals with an output generated by the oscillator. The mixer may be adapted to generate baseband cellular signals corresponding to the received cellular RF signals and also generate baseband VHF/UHF broadcast signals corresponding to the received VHF/UHF broadcast RF signals.

### CROSS-REFERENCE TO RELATED APPLICATIONS/INCORPORATION BY REFERENCE

This application makes reference to:

U.S. patent application Ser. No. ______ (Attorney Docket No. 16330US01), filed Dec. 13, 2004;

U.S. patent application Ser. No. ______ (Attorney Docket No. 16331US01), filed Dec. 13, 2004;

U.S. patent application Ser. No. ______ (Attorney Docket No. 16332US01), filed Dec. 13, 2004;

U.S. patent application Ser. No. ______ (Attorney Docket No. 16333US01), filed Dec. 13, 2004;

U.S. patent application Ser. No. ______ (Attorney Docket No. 16334US01), filed Dec. 13, 2004;

U.S. patent application Ser. No. ______ (Attorney Docket No. 16335US01), filed Dec. 13, 2004;

U.S. patent application Ser. No. ______ (Attorney Docket No. 16336US01), filed Dec. 13, 2004;

U.S. patent application Ser. No. ______ (Attorney Docket No. 16337US01), filed Dec. 13, 2004;

U.S. patent application Ser. No. ______ (Attorney Docket No. 16338US01), filed Dec. 13, 2004;

U.S. patent application Ser. No. ______ (Attorney Docket No. 16339US01), filed Dec. 13, 2004;

U.S. patent application Ser. No. ______ (Attorney Docket No. 16340US01), filed Dec. 13, 2004;

U.S. patent application Ser. No. ______ (Attorney Docket No. 16341US01), filed Dec. 13, 2004;

U.S. patent application Ser. No. ______ (Attorney Docket No. 16342US01), filed Dec. 13, 2004.

U.S. patent application Ser. No. ______ (Attorney Docket No. 16343US01), filed Dec. 13, 2004;

U.S. patent application Ser. No. ______ (Attorney Docket No. 16344US01), filed Dec. 13, 2004;

U.S. patent application Ser. No. ______ (Attorney Docket No. 16345US01), filed Dec. 13, 2004; and

U.S. patent application Ser. No. ______ (Attorney Docket No. 16346US01), filed Dec. 13, 2004.

All of the above stated applications are hereby incorporated herein by reference in their entirety.

### FIELD OF THE INVENTION

Certain embodiments of the invention relate to communication of information via a plurality of different networks. More specifically, certain embodiments of the invention relate to a method and system for receiver front end (RF) architecture supporting broadcast utilizing a fractional N synthesizer for European, World, and US wireless bands.

### BACKGROUND OF THE INVENTION

Broadcasting and telecommunications have historically occupied separate fields. In the past, broadcasting was largely an “over-the-air” medium while wired media carried telecommunications. That distinction may no longer apply as both broadcasting and telecommunications may be delivered over either wired or wireless media. Present development may adapt broadcasting to mobility services. One limitation has been that broadcasting may often require high bit rate data transmission at rates higher than could be supported by existing mobile communications networks. However, with emerging developments in wireless communications technology, even this obstacle may be overcome.

Terrestrial television and radio broadcast networks have made use of high power transmitters covering broad service areas, which enable one-way distribution of content to user equipment such as televisions and radios. By contrast, wireless telecommunications networks have made use of low power transmitters, which have covered relatively small areas known as “cells”. Unlike broadcast networks, wireless networks may be adapted to provide two-way interactive services between users of user equipment such as telephones and computer equipment.

The introduction of cellular communications systems in the late 1970's and early 1980's represented a significant advance in mobile communications. The networks of this period may be commonly known as first generation, or “1G” systems. These systems were based upon analog, circuit-switching technology, the most prominent of these systems may have been the advanced mobile phone system (AMPS). Second generation, or “2G” systems ushered improvements in performance over 1G systems and introduced digital technology to mobile communications. Exemplary 2G systems include the global system for mobile communications (GSM), digital AMPS (D-AMPS), and code division multiple access (CDMA). Many of these systems have been designed according to the paradigm of the traditional telephony architecture, often focused on circuit-switched services, voice traffic, and supported data transfer rates up to 14.4 kbits/s. Higher data rates were achieved through the deployment of “2.5G” networks, many of which were adapted to existing 2G network infrastructures. The 2.5G networks began the introduction of packet-switching technology in wireless networks. However, it is the evolution of third generation, or “3G” technology which may introduce fully packet-switched networks, which support high-speed data communications.

The general packet radio service (GPRS), which is an example of a 2.5G network service oriented for data communications, comprises enhancements to GSM which required additional hardware and software elements in existing GSM network infrastructures. Where GSM may allot a single time slot in a time division multiple access (TDMA) frame, GPRS may allot up to 8 such time slots providing a data transfer rate of up to 115.2 kbits/s. Another 2.5G network, enhanced data rates for GSM evolution (EDGE), also comprises enhancements to GSM, and like GPRS, EDGE may allocate up to 8 time slots in a TDMA frame for packet-switched, or packet mode, transfers. However, unlike GPRS, EDGE adapts 8 phase shift keying (8-PSK) modulation to achieve data transfer rates which may be as high as 384 kbits/s.

The universal mobile telecommunications system (UMTS) is an adaptation of a 3G system, which is designed to offer integrated voice, multimedia, and Internet access services to portable user equipment. The UMTS adapts wideband CDMA (W-CDMA) to support data transfer rates, which may be as high as 2 Mbits/s. One reason why W-CDMA may support higher data rates is that W-CDMA channels may have a bandwidth of 5 MHz versus the 200 kHz channel bandwidth in GSM. A related 3G technology, high speed downlink packet access (HSDPA), is an Internet protocol (IP) based service oriented for data communications, which adapts W-CDMA to support data transfer rates of the order of 10 Mbits/s. HSDPA achieves higher data rates through a plurality of methods. For example, many transmission decisions may be made at the base station level, which is much closer to the user equipment as opposed to being made at a mobile switching center or office. These may include decisions about the scheduling of data to be transmitted, when data are to be retransmitted, and assessments about the quality of the transmission channel. HSDPA may also utilize variable coding rates in transmitted data. HSDPA also supports 16-level quadrature amplitude modulation (16-QAM) over a high-speed downlink shared channel (HS-DSCH), which permits a plurality of users to share an air interface channel.

The multiple broadcast/multicast service (MBMS) is an IP datacast service, which may be deployed in EDGE and UMTS networks. The impact of MBMS is largely within the network in which a network element adapted to MBMS, the broadcast multicast service center (BM-SC), interacts with other network elements within a GSM or UMTS system to manage the distribution of content among cells within a network. User equipment may be required to support functions for the activation and deactivation of MBMS bearer service. MBMS may be adapted for delivery of video and audio information over wireless networks to user equipment. MBMS may be integrated with other services offered over the wireless network to realize multimedia services, such as multicasting, which may require two-way interaction with user equipment.

Standards for digital television terrestrial broadcasting (DTTB) have evolved around the world with different systems being adopted in different regions. The three leading DTTB systems are, the advanced standards technical committee (ATSC) system, the digital video broadcast terrestrial (DVB-T) system, and the integrated service digital broadcasting terrestrial (ISDB-T) system. The ATSC system has largely been adopted in North America, South America, Taiwan, and South Korea. This system adapts trellis coding and 8-level vestigial sideband (8-VSB) modulation. The DVB-T system has largely been adopted in Europe, the Middle East, Australia, as well as parts of Africa and parts of Asia. The DVB-T system adapts coded orthogonal frequency division multiplexing (COFDM). The ISDB-T system has been adopted in Japan and adapts bandwidth segmented transmission orthogonal frequency division multiplexing (BST-OFDM). The various DTTB systems may differ in important aspects, some systems employ a 6 MHz channel separation, while others may employ 7 MHz or 8 MHz channel separations. Planning for the allocation of frequency spectrum may also vary among countries with some countries integrating frequency allocation for DTTB services into the existing allocation plan for legacy analog broadcasting systems. In such instances, broadcast towers for DTTB may be co-located with broadcast towers for analog broadcasting services with both services being allocated similar geographic broadcast coverage areas. In other countries, frequency allocation planning may involve the deployment of single frequency networks (SFNs), in which a plurality of towers, possibly with overlapping geographic broadcast coverage areas (also known as “gap fillers”), may simultaneously broadcast identical digital signals. SFNs may provide very efficient use of broadcast spectrum as a single frequency may be used to broadcast over a large coverage area in contrast to some of the conventional systems, which may be used for analog broadcasting, in which gap fillers transmit at different frequencies to avoid interference.

Even among countries adopting a common DTTB system, variations may exist in parameters adapted in a specific national implementation. For example, DVB-T not only supports a plurality of modulation schemes, comprising quadrature phase shift keying (QPSK), 16-QAM, and 64 level QAM (64-QAM), but DVB-T offers a plurality of choices for the number of modulation carriers to be used in the COFDM scheme. The “2K” mode permits 1,705 carrier frequencies which may carry symbols, each with a useful duration of 224 μs for an 8 MHz channel. In the “8K” mode there are 6,817 carrier frequencies, each with a useful symbol duration of 896 μs for an 8 MHz channel. In SFN implementations, the 2K mode may provide comparatively higher data rates but smaller geographical coverage areas than may be the case with the 8K mode. Different countries adopting the same system may also employ different channel separation schemes.

While 3G systems are evolving to provide integrated voice, multimedia, and data services to mobile user equipment, there may be compelling reasons for adapting DTTB systems for this purpose. One of the more notable reasons may be the high data rates which may be supported in DTTB systems. For example, DVB-T may support data rates of 15 Mbits/s in an 8 MHz channel in a wide area SFN. There are also significant challenges in deploying broadcast services to mobile user equipment. Many handheld portable devices, for example, may require that services consume minimum power to extend battery life to a level, which may be acceptable to users. Another consideration is Doppler effect in moving user equipment, which may cause inter-symbol interference in received signals. Among the three major DTTB systems, ISDB-T was originally designed to support broadcast services to mobile user equipment. While DVB-T may not have been originally designed to support mobility broadcast services, a number of adaptations have been made to provide support for mobile broadcast capability. The adaptation of DVB-T to mobile broadcasting is commonly known as DVB handheld (DVB-H).

To meet requirements for mobile broadcasting the DVB-H specification may support time slicing to reduce power consumption at the user equipment, addition of a 4K mode to enable network operators to make tradeoffs between the advantages of the 2K mode and those of the 8K mode, and an additional level of forward error correction on multiprotocol encapsulated data—forward error correction (MPE-FEC) to make DVB-H transmissions more robust to the challenges presented by mobile reception of signals and to potential limitations in antenna designs for handheld user equipment. DVB-H may also use the DVB-T modulation schemes, like QPSK and 16-quadrature amplitude modulation (16-QAM), which may be most resilient to transmission errors. MPEG audio and video services may be more resilient to error than data, thus additional forward error correction may not be required to meet DTTB service objectives.

Time slicing may reduce power consumption in user equipment by increasing the burstiness of data transmission. Instead of transmitting data at the received rate, under time slicing techniques, the transmitter may delay the sending of data to user equipment and send data later but at a higher bit rate. This may reduce total data transmission time over the air, time, which may be used to temporarily power down the receiver at the user equipment. Time slicing may also facilitate service handovers as user equipment moves from one cell to another because the delay time imposed by time slicing may be used to monitor transmitters in neighboring cells. The MPE-FEC may comprise Reed-Solomon coding of IP data packets, or packets using other data protocols. The 4K mode in DVB-H may utilize 3,409 carriers, each with a useful duration of 448 μs for an 8 MHz channel. The 4K mode may enable network operators to realize greater flexibility in network design at minimum additional cost. Importantly, DVB-T and DVB-H may coexist in the same geographical area. Transmission parameter signaling (TPS) bits which are carried in the header of transmitted messages may indicate whether a given DVB transmission is DVB-T or DVB-H, in addition to indicating whether DVB-H specific features, such as time slicing, or MPE-FEC are to be performed at the receiver. As time slicing may be a mandatory feature of DVB-H, an indication of time slicing in the TPS may indicate that the received information is from a DVB-H service.

With the convergence of next generation networks which offer a plurality integrated services which may be offered in disparate conventional networks come requirements for new capabilities in mobile terminals. Some conventional mobile terminals may be adapted to communicating with cellular networks only, while some receiver devices may be adapted to the reception of television and radio services only. Thus, users who wish to receive both broadcast and telecommunications services while mobile may be required to carry at least two devices, a mobile telephone, and one or more devices for the reception of television and radio broadcast services.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for a receiver front end (RFE) architecture supporting broadcast utilizing a fractional N synthesizer for European, World, and US wireless bands. Aspects of the method may comprise controlling, in a mobile terminal that receives and processes cellular RF signals and VHF/UHF broadcast RF signals, an oscillator utilized for mixing via a fractional N synthesizer. Received cellular RF signals and received VHF/UHF broadcast RF signals may be converted in the mobile terminal to corresponding baseband cellular signals and baseband VHF/UHF broadcast signals, respectively. In the mobile terminal, at least one control signal may be generated from at least one baseband processing circuit that may be utilized to convert the cellular RF signals and the received VHF/UHF broadcast RF signals to corresponding baseband cellular signals and baseband VHF/UHF broadcast signals. The control signal may comprise a fractional word and an integer word.

The method may further comprise controlling the fractional N synthesizer via at least one external divider input signal. A quadrature output timing signal and a corresponding in-phase output timing signal may be generated within the mobile terminal. The timing signals may be utilized to control a first oscillator that converts the received cellular RF signals and VHF/UHF broadcast RF signals, to corresponding baseband cellular signals and baseband VHF/UHF broadcast signals, respectively. At least one output signal may be generated within the mobile terminal from the first oscillator. The generated output signal may be mixed with the received cellular RF signals and VHF/UHF broadcast RF signals. A reference signal from a second oscillator may be received as an input to the fractional N synthesizer within the mobile terminal. At least one filter control signal may be generated by the fractional N synthesizer in the mobile terminal that controls at least one external loop filter. The received cellular RF signals may comprise global system for mobile communications (GSM), general packet radio service (GPRS), enhanced data rates for GSM evolution (EDGE), code division multiple access 2000 (CDMA2000), wideband CDMA (WCDMA), high speed downlink packet access (HSDPA) systems, and multiple broadcast/multicast service (MBMS) signals. The received VHF/UHF broadcast RF signals may comprise ATSC, ISDB and a DVB signals.

Certain embodiments of the invention may be found in a method and system for a receiver front end (RFE) architecture supporting broadcast utilizing a fractional N synthesizer for European, World, and US wireless bands. Aspects of the method may comprise controlling, in a mobile terminal that receives and processes cellular RF signals and VHF/UHF broadcast RF signals, an oscillator utilized for mixing via a fractional N synthesizer. Received cellular RF signals and received VHF/UHF broadcast RF signals may be converted in the mobile terminal to corresponding baseband cellular signals and baseband VHF/UHF broadcast signals, respectively. In the mobile terminal, at least one control signal may be generated from at least one baseband processing circuit that may be utilized to convert the cellular RF signals and the received VHF/UHF broadcast RF signals to corresponding baseband cellular signals and baseband VHF/UHF broadcast signals. The control signal may comprise a fractional word and an integer word.

The method may further comprise controlling the fractional N synthesizer via at least one external divider input signal. A quadrature output timing signal and a corresponding in-phase output timing signal may be generated within the mobile terminal. The timing signals may be utilized to control a first oscillator that converts the received cellular RF signals and VHF/UHF broadcast RF signals, to corresponding baseband cellular signals and baseband VHF/UHF broadcast signals, respectively. At least one output signal may be generated within the mobile terminal from the first oscillator. The generated output signal may be mixed with the received cellular RF signals and VHF/UHF broadcast RF signals. A reference signal from a second oscillator may be received as an input to the fractional N synthesizer within the mobile terminal. At least one filter control signal may be generated by the fractional N synthesizer in the mobile terminal that controls at least one external loop filter. The received cellular RF signals may comprise global system for mobile communications (GSM), general packet radio service (GPRS), enhanced data rates for GSM evolution (EDGE), code division multiple access 2000 (CDMA2000), wideband CDMA (WCDMA), high speed downlink packet access (HSDPA) systems, and multiple broadcast/multicast service (MBMS) signals. The received VHF/UHF broadcast RF signals may comprise ATSC, ISDB and a DVB signals.

Aspects of the system may comprise circuitry in a mobile terminal that receives and processes cellular RF signals and VHF/UHF broadcast RF signals, and controls an oscillator utilized for mixing via a fractional N synthesizer. Circuitry in the mobile terminal may convert the received cellular RF signals and the received VHF/UHF broadcast RF signals to corresponding baseband cellular signals and baseband VHF/UHF broadcast signals, respectively. Circuitry in the mobile terminal may generate at least one control signal from at least one baseband processing circuit that may be utilized to convert the received cellular RF signals and the received VHF/UHF broadcast RF signals to corresponding baseband cellular signals and baseband VHF/UHF broadcast signals. The control signal may comprise a fractional word and an integer word.

The system may further comprise circuitry in the mobile terminal that controls the fractional N synthesizer via at least one external divider input signal. A quadrature output timing signal and a corresponding in-phase output timing signal may be generated via circuitry in the mobile terminal. The timing signals may be utilized to control a first oscillator that converts the received cellular RF signals and VHF/UHF broadcast RF signals, to corresponding baseband cellular signals and baseband VHF/UHF broadcast signals, respectively. Circuitry in the mobile terminal may generate at least one output signal from the first oscillator. Circuitry in the mobile terminal may the generated output signal with the received cellular RF signals and VHF/UHF broadcast RF signals. A reference signal from a second oscillator may be received as an input to the fractional N synthesizer within the mobile terminal. At least one filter control signal may be generated by the fractional N synthesizer in the mobile terminal that controls at least one external loop filter. The received cellular RF signals may comprise global system for mobile communications (GSM), general packet radio service (GPRS), enhanced data rates for GSM evolution (EDGE), code division multiple access 2000 (CDMA2000), wideband CDMA (WCDMA), high speed downlink packet access (HSDPA) systems, and multiple broadcast/multicast service (MBMS) signals. The received VHF/UHF broadcast RF signals may comprise ATSC, ISDB and a DVB signals.

Aspects of a system for communicating information via a plurality of different networks comprises a mobile terminal comprising a mixer and an oscillator coupled to the mixer. The mobile terminal may comprise a fractional N synthesizer coupled to the mixer. The mixer is adapted to mix, within the mobile terminal, received cellular RF signals and received VHF/UHF broadcast RF signals with an output generated by the oscillator. The mixer may be adapted to generate baseband cellular signals corresponding to the received cellular RF signals and also generate baseband VHF/UHF broadcast signals corresponding to the received VHF/UHF broadcast RF signals.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1a is a block diagram of an exemplary system for providing integrated services between a cellular network and a digital video broadcast network, in accordance with an embodiment of the invention.

FIG. 1b is a high-level block diagram of exemplary DVB-H receiver circuitry in a mobile terminal, which may be utilized in connection with an embodiment of the invention.

FIG. 1c is a block diagram illustrating the sharing of a multiplexer (MUX) by a plurality of MPEG2 services, which may be utilized in connection with an embodiment of the invention.

FIG. 2a is a block diagram of a mobile terminal that is adapted to receive VHF/UHF broadcasts and cellular communications, in accordance with an embodiment of the invention.

FIG. 2b is a block diagram illustrating receive processing circuit of an RF integrated circuit (RFIC), in accordance with an embodiment of the invention.

FIG. 2c is a high-level block diagram illustrating an exemplary configuration for a RFIC and a base band processing circuit, in accordance with an embodiment of the invention.

FIG. 3 is a block diagram illustrating an exemplary fractional N synthesizer for European, World and US wireless bands, in accordance with an embodiment of the invention.

FIG. 4 is an exemplary flow diagram illustrating the operation of the fractional N synthesizer for European, World, and US wireless bands, in accordance with an embodiment of the invention.

FIG. 5 is a block diagram of a mobile terminal that may be utilized in accordance with an embodiment of the invention.

### DETAILED DESCRIPTION OF THE INVENTION

Certain embodiments of the invention may be found in a method and system for a receiver front end (RFE) architecture supporting broadcast utilizing a fractional N synthesizer for European, World, and US wireless bands. Aspects of the method may comprise controlling, in a mobile terminal that receives and processes cellular RF signals and VHF/UHF broadcast RF signals, an oscillator utilized for mixing via a fractional N synthesizer. Received cellular RF signals and received VHF/UHF broadcast RF signals may be converted in the mobile terminal to corresponding baseband cellular signals and baseband VHF/UHF broadcast signals, respectively. In the mobile terminal, at least one control signal may be generated from at least one baseband processing circuit that may be utilized to convert the cellular RF signals and the received VHF/UHF broadcast RF signals to corresponding baseband cellular signals and baseband VHF/UHF broadcast signals. The control signal may comprise a fractional word and an integer word.

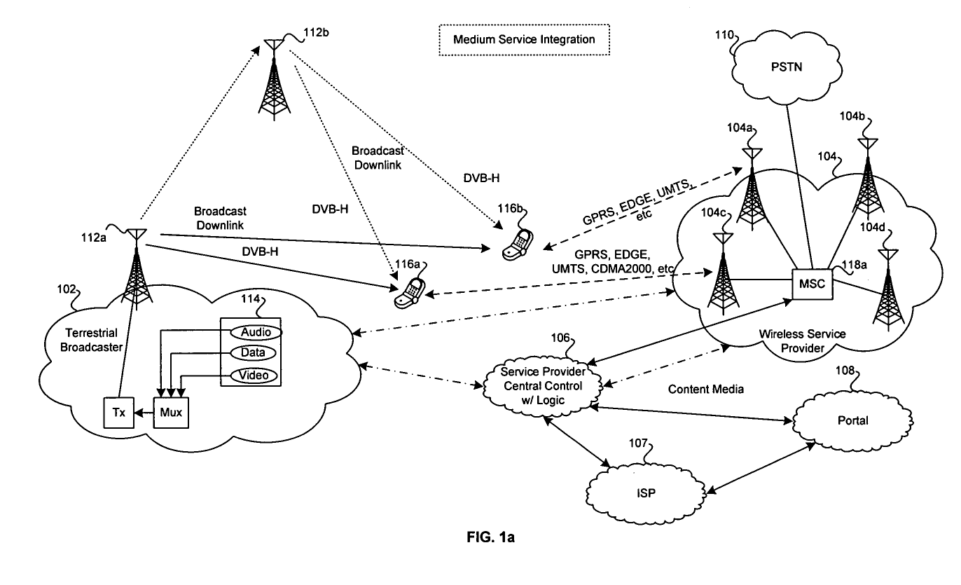

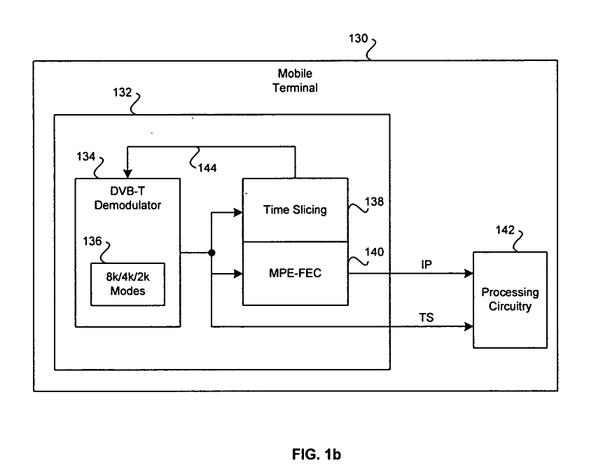

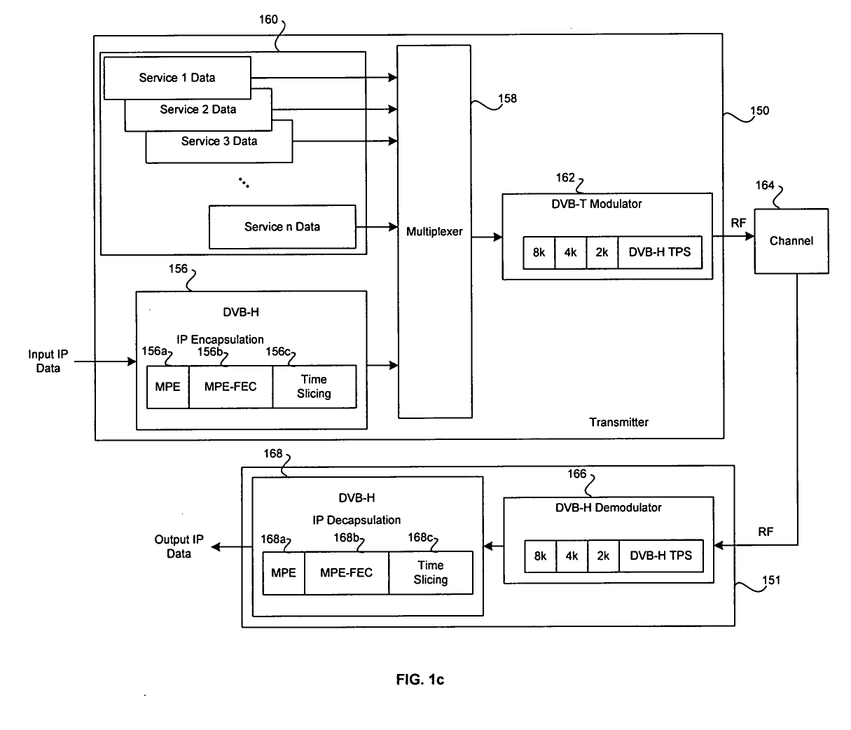

FIG. 1a is a block diagram of an exemplary system for providing integrated services between a cellular network and a digital video broadcast network, in accordance with an embodiment of the invention. Referring to FIG. 1a, there is shown terrestrial broadcaster network 102, wireless service provider network 104, service provider 106, an Internet service provider (ISP) 107, a portal 108, public switched telephone network 110, and mobile terminals (MTs) 116a and 116b. The terrestrial broadcaster network 102 may comprise transmitter (Tx) 102a, multiplexer (Mux) 102b, and information content source 114. The content source 114 may also be referred to as a data carousel, which may comprise audio, data and video content. The terrestrial broadcaster network 102 may also comprise VHF/UHF broadcast antennas 112a and 112b. The wireless service provider network 104 may comprise mobile switching center (MSC) 118a, and a plurality of cellular base stations 104a, 104b, 104c, and 104d.

The terrestrial broadcaster network 102 may comprise suitable equipment that may be adapted to encode and/or encrypt data for transmission via the transmitter 102a. The transmitter 102a in the terrestrial broadcast network 102 may be adapted to utilize VHF/UHF broadcast channels to communicate information to the mobile terminals 116a, 116b. The multiplexer 102b associated with the terrestrial broadcaster network 102 may be utilized to multiplex data from a plurality of sources. For example, the multiplexer 102b may be adapted to multiplex various types of information such as audio, video and/or data into a single pipe for transmission by the transmitter 102a. Content media from the portal 108, which may be handled by the service provider 106 may also be multiplexed by the multiplexer 102b. The portal 108 may be an ISP service provider.

Although communication links between the terrestrial broadcast network 102 and the service provider 106, and also the communication links between the service provider 106 and the wireless service provider 104 may be wired communication links, the invention may be not so limited. Accordingly, at least one of these communication links may be wireless communication links. In an exemplary embodiment of the invention, at least one of these communication links may be an 802.x based communication link such an 802.16 or WiMax broadband access communication link. In another exemplary embodiment of the invention, at least one of these connections may be a broadband line of sight (LOS) connection.

The wireless service provider network 104 may be a cellular or personal communication service (PCS) provider. The term cellular as utilized herein refers to both cellular and PCS frequencies bands. Hence, usage of the term cellular may comprise any band of frequencies that may be utilized for cellular communication and/or any band of frequencies that may be utilized for PCS communication. The wireless service provider network 104 may utilize cellular or PCS access technologies such as GSM, CDMA, CDMA2000, WCDMA, AMPS, N-AMPS, and/or TDMA. The cellular network may be utilized to offer bi-directional services via uplink and downlink communication channels. In this regard, other bidirectional communication methodologies comprising uplink and downlink capabilities, whether symmetric or asymmetric, may be utilized.

Although the wireless service provider network 104 is illustrated as a GSM, CDMA, WCDMA based network and/or variants thereof, the invention is not limited in this regard. Accordingly, the wireless service provider network 104 may be an 802.11 based wireless network or wireless local area network (WLAN). The wireless service provider network 104 may also be adapted to provide 802.11 based wireless communication in addition to GSM, CDMA, WCDMA, CDMA2000 based network and/or variants thereof. In this case, the mobile terminals 116a, 116b may also be compliant with the 802.11 based wireless network.

In accordance with an exemplary embodiment of the invention, if the mobile terminal (MT) 116a is within an operating range of the VHF/UHF broadcasting antenna 112a and moves out of the latter's operating range and into an operating range of the VHF/UHF broadcasting antenna 112b, then VHF/UHF broadcasting antenna 112b may be adapted to provide UHFNHF broadcast services to the mobile terminal 116a. If the mobile terminal 116a subsequently moves back into the operating range of the VHF/UHF broadcasting antenna 112a, then the broadcasting antenna 112a may be adapted to provide VHF/UHF broadcasting service to the mobile terminal 116a. In a somewhat similar manner, if the mobile terminal (MT) 116b is within an operating range of the VHF/UHF broadcasting antenna 112b and moves out of the latter's operating range and into an operating range of the broadcasting antenna 112a, then the VHF/UHF broadcasting antenna 112a may be adapted to provide VHF/UHF broadcasting service to the mobile terminal 116b. If the mobile terminal 116b subsequently moves back into the operating range of broadcasting antenna 112b, then the VHF/UHF broadcasting antenna 112b may be adapted to provide VHF/UHF broadcast services to the mobile terminal 116b.

The service provider 106 may comprise suitable interfaces, circuitry, logic and/or code that may be adapted to facilitate communication between the terrestrial broadcasting network 102 and the wireless communication network 104. In an illustrative embodiment of the invention the service provider 106 may be adapted to utilize its interfaces to facilitate exchange control information with the terrestrial broadcast network 102 and to exchange control information with the wireless service provider 104. The control information exchanged by the service provider 106 with the terrestrial broadcasting network 102 and the wireless communication network 104 may be utilized to control certain operations of the mobile terminals, the terrestrial broadcast network 102 and the wireless communication network 104.

In accordance with an embodiment of the invention, the service provider 106 may also comprise suitable interfaces, circuitry, logic and/or code that may be adapted to handle network policy decisions. For example, the service provider 106 may be adapted to manage a load on the terrestrial broadcast network 102 and/or a load on the wireless service provider network 104. Load management may be utilized to distribute the flow of information throughout the terrestrial broadcast network 104 and/or a load on the wireless service provider network 104. For example, if information is to be broadcasted via the wireless service provider network 104 to a plurality of mobile terminals within a particular cell handled by the base station 104a and it is determined that this may overload the wireless service provider network 104, then the terrestrial broadcast network 102 may be configured to broadcast the information to the mobile terminals.

The service provider 106 may also be adapted to handle certain types of service requests, which may have originated from a mobile terminal. For example, the mobile terminal 116a may request that information be delivered to it via a downlink VHF/UHF broadcast channel. However, a downlink VHF/UHF broadcast channel may be unavailable for the delivery of the requested information. As a result, the service provider 106 may route the requested information through a cellular channel via the base station 104c to the mobile terminal 116a. The requested information may be acquired from the content source 114, the ISP 107, and/or the portal 108. In another example, the mobile terminal 116b may request that information be delivered to it via a downlink cellular channel. However, the service provider 106 may determine that delivery of the information is not critical and/or the cheapest way to deliver to the mobile terminal 116b is via a downlink VHF/UHF broadcast channel. As a result, the service provider 106 may route the requested information from the ISP 107, the portal 108 or content service 114 to the mobile terminal 116b. The service provider 106 may also have the capability to send at least a portion of information to be delivered to, for example, mobile terminal 116a via the VHF/UHF broadcast channel and a remaining portion of the information to be delivered via a cellular channel.

The ISP 107 may comprise suitable logic, circuitry and/or code that may be adapted to provide content media to the service provider 106 via one or more communication links. These communication links, although not shown, may comprise wired and/or wireless communication links. The content media that may be provided by the ISP 107 may comprise audio, data, video or any combination thereof. In this regard, the ISP 107 may be adapted to provide one or more specialized information services to the service provider 106.

The portal 108 may comprise suitable logic, circuitry and/or code that may be adapted to provide content media to the service provider 106 via one or more communication links. These communication links, although not shown, may comprise wired and/or wireless communication links. The content media that may be provided by the portal 108 may comprise audio, data, video or any combination thereof. In this regard, the portal 108 may be adapted to provide one or more specialized information services to the service provider 106.

The public switched telephone network (PSTN) 110 may be coupled to the MSC 118a. Accordingly, the MSC 118a may be adapted to switch calls originating from within the PSTN 110 to one or more mobile terminals serviced by the wireless service provider 104. Similarly, the MSC 118a may be adapted to switch calls originating from mobile terminals serviced by the wireless service provider 104 to one or more telephones serviced by the PSTN 110.

The information content source 114 may comprise a data carousel. In this regard, the information content source 114 may be adapted to provide various information services, which may comprise online data including audio, video and data content. The information content source 114 may also comprise file download, and software download capabilities. In instances where a mobile terminal fails to acquire requested information from the information content source 114 or the requested information is unavailable, then the mobile terminal may acquire the requested information via, for example, a cellular channel from the ISP 107 and/or the portal 108. The request may be initiated through an uplink cellular communication path.

The mobile terminals (MTs) 116a and 116b may comprise suitable logic, circuitry and/or code that may be adapted to handle the processing of uplink and downlink cellular channels for various access technologies and broadcast UHFNHF technologies. In an exemplary embodiment of the invention, the mobile terminals 116a, 116b may be adapted to utilize one or more cellular access technologies such as GSM, GPRS, EDGE, CDMA, WCDMA, and CDMA2000. The mobile terminal may also be adapted to receive and process VHF/UHF broadcast signals in the VHF/UHF bands. For example, a mobile terminal may be adapted to receive and process DVB-H signals. A mobile terminal may be adapted to request information via a first cellular service and in response, receive corresponding information via a VHF/UHF broadcast service. A mobile terminal may also be adapted to request information from a service provider via a cellular service and in response, receive corresponding information via a data service, which is provided via the cellular service. A mobile terminal may also be adapted to request Internet information from an Internet service provider. The mobile terminals may be adapted to receive VHF/UHF broadcast information from the VHF/UHF broadcast antennas 112a and 112b. In some instances, the mobile terminal may communicate corresponding uplink information via an uplink cellular communication channel.

In one embodiment of the invention, a mobile terminal may be adapted to utilize a plurality of broadcast integrated circuits for receiving and processing VHF/UHF channels, and a plurality of cellular integrated circuits for receiving and processing cellular or PCS channels. In this regard, the plurality of cellular integrated circuits may be adapted to handle different cellular access technologies. For example, at least one of the cellular integrated circuits may be adapted to handle GSM, and at least one of the cellular integrated circuits may be adapted to handle WCDMA. For broadcast channels, each of the plurality of broadcast integrated circuits may be adapted to handle at least one VHF/UHF channel.

In another embodiment of the invention, a mobile terminal may be adapted to utilize a single broadcast integrated circuit for receiving and processing VHF/UHF channels, and a single cellular integrated circuit for receiving and processing cellular or PCS channels. In this regard, the single cellular integrated circuit may be adapted to handle different cellular access technologies. For example, at least one of the cellular integrated circuit may be adapted to handle GSM, and at least one of the cellular integrated circuits may be adapted to handle WCDMA. For broadcast channels, the single broadcast integrated circuit may be adapted to handle at least one VHF/UHF channel. Each of the mobile terminals may comprise a single memory interface that may be adapted to handle processing of the broadcast communication information and processing of cellular communication information. In this regard, an uplink cellular communication path may be utilized to facilitate receiving of broadcast information via a broadcast communication path.

In another embodiment of the invention, a mobile terminal may be adapted to utilize a single integrated circuit for receiving and processing broadcast VHF/UHF channels, and for receiving and processing cellular or PCS channels. In this regard, the single broadcast and cellular integrated circuit may be adapted to handle different cellular access technologies. For example, the single integrated circuit may comprise a plurality of modules each of which may be adapted to receive and process a particular cellular access technology or a VHF/UHF broadcast channel. Accordingly, a first module may be adapted to handle GSM, a second module may be adapted to handle WCDMA, and a third module may be adapted to handle at least one VHF/UHF channel.

FIG. 1b is a high-level block diagram of exemplary DVB-H receiver circuitry in a mobile terminal, which may be utilized in connection with an embodiment of the invention. Referring to FIG. 1b, there is shown a mobile terminal 130. The mobile terminal 130 may comprise a DVB-H demodulator 132 and processing circuitry block 142. The DVB-H demodulator block 132 may comprise a DVB-T demodulator 134, time slicing block 138, and MPE-FEC block 140.

The DVB-T demodulator 134 may comprise suitable circuitry, logic and/or code that may be adapted to demodulate a terrestrial DVB signal. In this regard, the DVB-T demodulator 134 may be adapted to downconvert a received DVB-T signal to a suitable bit rate that may be handled by the mobile terminal 130. The DVB-T demodulator may be adapted to handle 2k, 4k and/or 8k modes.

The time slicing block 138 may comprise suitable circuitry, logic and/or code that may be adapted to minimize power consumption in the mobile terminal 130, particularly in the DVB-T demodulator 134. In general, time slicing reduces average power consumption in the mobile terminal by sending data in bursts via much higher instantaneous bit rates. In order to inform the DVB-T demodulator 134 when a next burst is going to be sent, a delta indicating the start of the next burst is transmitted within a current burst. During transmission, no data for an elementary stream (ES) is transmitted so as to allow other elementary streams to optimally share the bandwidth. Since the DVB-T demodulator 134 knows when the next burst will be received, the DVB-T demodulator 134 may enter a power saving mode between bursts in order to consume less power. Reference 144 indicates a control mechanism that handles the DVB-T demodulator 134 power via the time slicing block 138. The DVB-T demodulator 134 may also be adapted to utilize time slicing to monitor different transport streams from different channels. For example, the DVB-T demodulator 134 may utilize time slicing to monitor neighboring channels between bursts to optimize handover.

The MPE-FEC block 140 may comprise suitable circuitry, logic and/or code that may be adapted to provide error correction during decoding. On the encoding side, MPE-FEC encoding provides improved carrier to noise ratio (C/N), improved Doppler performance, and improved tolerance to interference resulting from impulse noise. During decoding, the MPE-FEC block 140 may be adapted to determine parity information from previously MPE-FEC encoded datagrams. As a result, during decoding, the MPE-FEC block 140 may generate datagrams that are error-free even in instances when received channel conditions are poor. The processing circuitry block 142 may comprise suitable processor, circuitry, logic and/or code that may be adapted to process IP datagrams generated from an output of the MPE-FEC block 140. The processing circuitry block 142 may also be adapted to process transport stream packets from the DVB-T demodulator 134.

In operation, the DVB-T demodulator 134 may be adapted to receive an input DVB-T RF signal, demodulate the received input DVB-T RF signal so as to generate data at a much lower bit rate. In this regard, the DVB-T demodulator 134 recovers MPEG-2 transport stream (TS) packets from the input DVB-T RF signal. The MPE-FEC block 140 may then correct any error that may be located in the data and the resulting IP datagrams may be sent to the processing circuitry block 142 for processing. Transport stream packets from the DVB-T demodulator 134 may also be communicated to the processing circuitry block 142 for processing.

FIG. 1c is a block diagram illustrating the sharing of a multiplexer (MUX) by a plurality of MPEG2 services, which may be utilized in connection with an embodiment of the invention. Referring to FIG. 1c, there is shown a transmitter block 150, a receiver block 151 and a channel 164. The transmitter block 150 may comprise a DVB-H encapsulator block 156, a multiplexer 158, and a DVB-T modulator 162. Also shown associated with the transmitter block 150 is a plurality of service data collectively referenced as 160. The receiver block 151 may comprise a DVB-H demodulator block 166 and a DVB-H decapsulation block 168. The DVB-H encapsulator block 156 may comprise MPE block 156a, MPE-FEC block 156b and time slicing block 156c.

The multiplexer 156 may comprise suitable logic circuitry and/or code that may be adapted to handle multiplexing of IP encapsulated DVB-H data and service data. The plurality of service data collectively referenced as 160 may comprise MPEG-2 formatted data, which may comprise for example, audio, video and/or data. The DVB-T modulator 162 may comprise suitable logic circuitry and/or code that may be adapted to generate an output RF signal from the transmitter block 150.

The DVB-H demodulator block 166 associated with the receiver block 151 is similar to the DVB-H demodulator block 132 of FIG. 1b. The DVB-H decapsulation block 168 may comprise MPE block 168a, MPE-FEC block 168b and time slicing block 168c. The DVB-H decapsulation block 168 may comprise suitable logic, circuitry and/or code that may be adapted decapsulate the IP data that was encapsulated and multiplexed by the transmitter block 150. The output of the DVB-H demodulator 166 is the transport stream packets, which comprised the multiplexed output generated by the multiplexer 158.

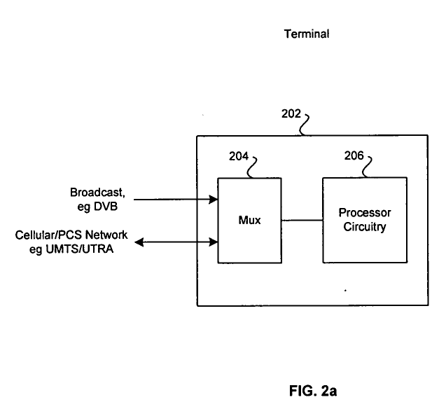

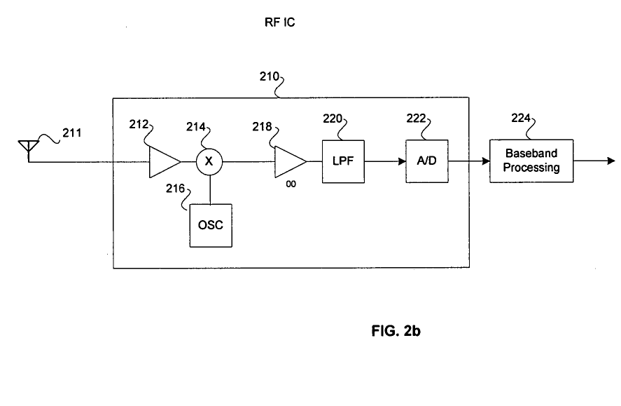

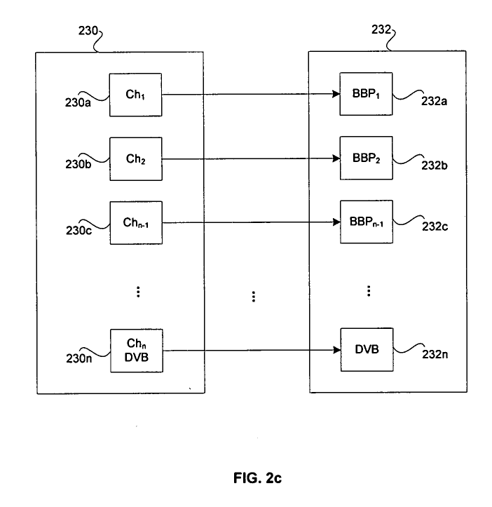

FIG. 2a is a block diagram of a mobile terminal that is adapted to receive VHF/UHF broadcasts and cellular communications, in accordance with an embodiment of the invention. Referring to FIG. 2a, there is shown mobile terminal (MT) or handset 202. The mobile terminal 202 may comprise multiplexer (MUX) 204 and processing circuitry 206.

The multiplexer 204 may comprise suitable logic circuitry and/or code that may be adapted to multiplex incoming signals, which may comprise VHF/UHF broadcast channel and at least one cellular channel. The cellular channel may be within the range of both cellular and PCS frequency bands.

The processing circuitry 206 may comprise, for example, an RF integrated circuit (RFIC) or RF front end (RFFE). In this regard, the processing circuitry 206 may comprise at least one receiver front end (RFE) circuit. A first of these circuits may be adapted to handle processing of the VHF/UHF broadcast channel and a second of these circuits may be adapted to handle a cellular channel. In an embodiment of the invention, a single RFIC may comprise a plurality of RFE processing circuits, each of which may be adapted to process a particular cellular channel. Accordingly, a single RFIC comprising a plurality of cellular RFE processing circuits may be adapted to handle a plurality of cellular channels. In one embodiment of the invention, a plurality of VHF/UHF RFE processing circuits may be integrated in a single RFIC. In this regard, a mobile terminal may be adapted to simultaneously handle a plurality of different VHF/UHF channels. For example, a mobile terminal may be adapted to simultaneously receive a first VHF/UHF channel bearing video and a second VHF/UHF channel bearing audio.

FIG. 2b is a block diagram illustrating receive processing circuit of an RF integrated circuit (RFIC), in accordance with an embodiment of the invention. Referring to FIG. 2b, there is shown antenna 211, receiver front end (RFE) circuit 210, and baseband processing block 224. The receiver front end (RFE) circuit 210 may comprise a low noise amplifier (LNA) 212, a mixer 214, an oscillator 216, a low noise amplifier or amplifier or amplifier 218, a low pass filter 220 and an analog-to-digital converter (A/D) 222.

The antenna 211 may be adapted to receive at least one of a plurality of signals. For example, the antenna 211 may be adapted to receive a plurality of signals in the GSM band, a plurality of signals in the WCDMA and and/or a plurality of signals in the VHF/UHF frequency band. U.S. application Ser. No. ______ (Attorney Docket No. 16343US01), U.S. application Ser. No. ______ (Attorney Docket No. 16344US01), U.S. application Ser. No. ______ (Attorney Docket No. 16345US01), all of which are filed on even date herewith and disclose various antenna configurations that may be utilized for a plurality of operating frequency bands.

The receiver front end (RFE) circuit 210 may comprise suitable circuitry, logic and/or code that may be adapted to convert a received RF signal down to baseband. An input of the low noise amplifier 212 may be coupled to the antenna 211 so that it may receive RF signals from the antenna 211. The low noise amplifier 212 may comprise suitable logic, circuitry, and/or code that may be adapted to receive an input RF signal from the antenna 211 and amplify the received RF signal in such a manner that an output signal generated by the low noise amplifier 212 has a very little additional noise.

The mixer 214 in the RFE circuit 210 may comprise suitable circuitry and/or logic that may be adapted to mix an output of the low noise amplifier 212 with an oscillator signal generated by the oscillator 216. The oscillator 216 may comprise suitable circuitry and/or logic that may be adapted to provide a oscillating signal that may be adapted to mix the output signal generated from the output of the low noise amplifier 212 down to a baseband. The low noise amplifier (LNA) or amplifier 218 may comprise suitable circuitry and/or logic that may be adapted to low noise amplify and output signal generated by the mixer 214. An output of the low noise amplifier or amplifier 218 may be communicated to the low pass filter 220. The low pass filter 220 may comprise suitable logic, circuitry and/or code that may be adapted to low pass filter the output signal generated from the output of the low noise amplifier 220. The low pass filter block 220 retains a desired signal and filters out unwanted signal components such as higher signal components comprising noise. An output of the low pass filter 220 may be communicated to the analog-digital-converter for processing.

The analog-to-digital converter (A/D) 222 may comprise suitable logic circuitry and/or code that may be adapted to convert the analog signal generated from the output of the low pass filter 220 to a digital signal. The analog-to-digital converter 222 may generate a sampled digital representation of the low pass filtered signal that may be communicated to the baseband-processing block 224 for processing. The baseband processing block 224 may comprise suitable logic, circuitry and/or code that may be adapted to process digital baseband signals received form an output of the A/D 222. Although the A/D 222 is illustrated as part of the RFE circuit 210, the invention may not be so limited. Accordingly, the A/D 222 may be integrated as part of the baseband processing block 224. In operation, the RFE circuit 210 is adapted to receive RF signals via antenna 211 and convert the received RF signals to a sampled digital representation, which may be communicated to the baseband processing block 224 for processing.

FIG. 2c is a high-level block diagram illustrating an exemplary configuration for a RFIC and a base band processing circuit, in accordance with an embodiment of the invention. Referring to FIG. 2c, there is shown RFIC 230 and baseband circuitry 232. The RFIC 230 comprises a plurality of RF processing circuits 230a, 230b, 230c and 230n. The RF processing circuits 230a, 230b, 230c and 230n may be integrated in a single integrated circuit (IC) or chip. The baseband processing circuitry 232 comprises a plurality of baseband processing circuits 232a, 232b, 232c and 232n. The baseband processing circuits 232a, 232b, 232c and 232n may be integrated into a single integrated circuit (IC) or chip.

In operation, each of the RF processing circuits in the RFIC 230 may be adapted to process a single channel. For example, each of the RF processing circuits 230a, 230b and 230c may be adapted to process separate cellular channel, namely, channel 1, channel 2 and channel (n-1), respectively. The RF processing circuit 230n many be adapted to process a VHF/UHF broadcast channel n.

Each of the baseband processing circuits in the baseband processing circuitry 230 may be adapted to process a single channel. For example, each of the baseband processing circuits 232a, 232b and 232c may be adapted to process separate cellular channels, namely, channel 1, channel 2 and channel (n-1), respectively. The RF processing circuit 232n may be adapted to process a VHF/UHF broadcast channel n. Use of a single RFIC and a single baseband processing integrated circuit saves on the size of the processing circuitry, which may significantly reduce cost.

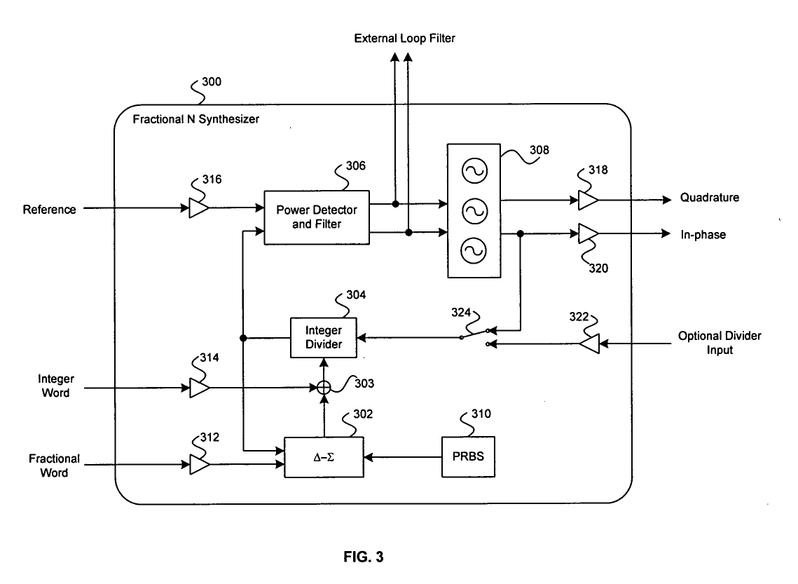

FIG. 3 is a block diagram illustrating an exemplary fractional N synthesizer for European, World and US wireless bands, in accordance with an embodiment of the invention. Referring to FIG. 3, there is shown a fractional N synthesizer 300 comprising a delta-sigma block 302, a summing block 303, an integer divider 304, a power detector and filter 306, a local oscillator 308, a pseudo random bit stream (PRBS) generator 310, a plurality of amplifiers 312, 314, 316, 318, 320, and 322, and a switch 324.

The delta-sigma block 302 may comprise suitable logic, circuitry and/or code that may be adapted to function as a low pass filter. The delta-sigma block 302 may comprise suitable logic, circuitry and/or code b that may be controlled by a fraction word, and by a feedback signal generated by the integer divider 304. The fractional word may be generated by a baseband processor, such as baseband processor 232c in FIG. 2c. The PRBS generator 310 may comprise suitable logic, circuitry and/or code that may be adapted to generate white noise which may be communicated to the delta-sigma block 302. The output from the delta-sigma block 302 may be summed with the integer word input at the summing block 303.

A baseband processor, 232c in FIG. 2c, may be utilized to generate the integer word. The signal generated by the summing block 303 may be utilized to control the integer divider 304, which may also receive an in-phase clock timing signal generated by the local oscillator 308. The signal generated by the integer divider 304 and the reference signal, which is buffered by amplifier 316, may be coupled to the power detector and filter block 306. The power detector and filter block 306 may comprise suitable logic, circuitry and/or code that may be adapted to generate timing control signals, which may be coupled to the local oscillator 308. The timing control signals generated by the power detector and filter block 306 may also be coupled to an external loop filter signal. The local oscillator 308 may generate a plurality of clock timing signals comprising a quadrature component, and an in-phase component.

The amplifiers 312, 314, 316, 318, 320, and 322 may be adapted to buffering input and output signals to and from the fractional N synthesizer 300. The amplifier 312 may be configured to buffer the fractional word input from the baseband processor, such as 232c in FIG. 2c, which is coupled to an RFIC, such as 230c in FIG. 2c, that receives clock timing signals from the fractional N synthesizer 300. The amplifier 314 may be configured to buffer the integer word input from the baseband processor, such as 232c in FIG. 2c, which is coupled to an RFIC, such as 230c in FIG. 2c, that receives clock timing signals from the fractional N synthesizer 300. The amplifier 316 may be adapted to buffer the reference signal from a crystal oscillator circuit. The amplifier 318 may be adapted to buffer the quadrature component of the clock timing signals generated by the local oscillator 308. The amplifier 320 may be adapted to buffer the in-phase component of the clock timing signals generated by the local oscillator 308. The amplifier 322 may buffer the optional divider input word.

In operation, a carrier frequency of a RF received signal by a mobile terminal, 202 in FIG. 2a, may not be known in advance. Accordingly, the baseband processor, such as 232c in FIG. 2c, may communicate a value for the fractional word and the integer word, which are communicated to the fractional N synthesizer, 300. The fractional N synthesizer may use the fractional word and the integer word to generate clock timing signals that may be used by the mixer, such as 214 in FIG. 2b, in an RFIC, such as 230c in FIG. 2c, to demodulate RF signals received by an antenna, such as 211 in FIG. 2b, at a mobile terminal, 202 in FIG. 2a. If the frequency utilized by an oscillator, such as 216 in FIG. 2b, in demodulating the received RF signal does not match the carrier frequency of the received RF signal, the RFIC, such as 210 in FIG. 2b, may not generate a valid baseband signal from the received RF signal. The baseband processor, such as 232c in FIG. 2c, may detect that the baseband signal received from an RFIC, such as 230c in FIG. 2c. In response, the baseband processor, 232c in FIG. 2c, may change the frequency used in demodulating the received RF signal by sending an integer word and a fractional word to the fractional N synthesizer 300, in which at least one of the group of input data signals, fractional word and integer word, are of a different value than was previously communicated to the RFIC, 230c in FIG. 2c, by the baseband processor, 232c in FIG. 2c. In response, the fractional N synthesizer 300 may generate clock timing signals at a different frequency. If the baseband processor, 232c in FIG. 2c, detects valid baseband signals at this time, the baseband processor, 232c in FIG. 2c, may maintain current values of the fractional word and integer word at the fractional N synthesizer 300. If the baseband processor, 232c in FIG. 2c, still receives invalid baseband signals from an RFIC, 230c in FIG. 2c, then the baseband processor, 232c in FIG. 2c, may send an integer word and a fractional word to the fractional N synthesizer 300, in which at least one of the group of input data signals, fractional word and integer word, are of a different value than was previously communicated to the RFIC, 230c in FIG. 2c, by the baseband processor, 232c in FIG. 2c.

In some instances, the delta-sigma block 302, may limit the frequency range in clock timing signals generated by the fractional N synthesizer 300 where a wider frequency range may be needed at the mixer, 214 in FIG. 2b. The PRBS 310 may generate a white noise signal, which may be communicated as an input to the delta-sigma block 302. This white noise signal may function as a notch filter and reduce noise in the clock timing signals generated at the local oscillator 308. However, in some instances the notch filter may not be wide enough. In these instances, clock timing signals with a wider frequency range may be generated by bypassing the delta-sigma block 302, and the PRBS 310. This may be achieved by effecting switch 324 to select input from amplifier 322, which buffers the optional divider input signal. The optional divider input signal may be received from the baseband processor, 232c in FIG. 2c.

In some instances, changing the frequency of the clock timing signals may result in undesirable oscillations in the clock timing signals generated by the fractional N synthesizer 300. This may produce clock timing signals which are not able to maintain a stable frequency, and may consequently degrade the function and performance of the RFIC, 230c in FIG. 2c, and of the baseband processor, 232c in FIG. 2c. In an aspect of the invention the external loop filter signals may be utilized to reduce oscillations when changing the frequency of the clock timing signals at fractional N synthesizer 300. Utilizing the external loop signals may reduce the time required to transition from one frequency in the clock timing signals generated by the local oscillator 308, to a different frequency in the generated clock timing signals.

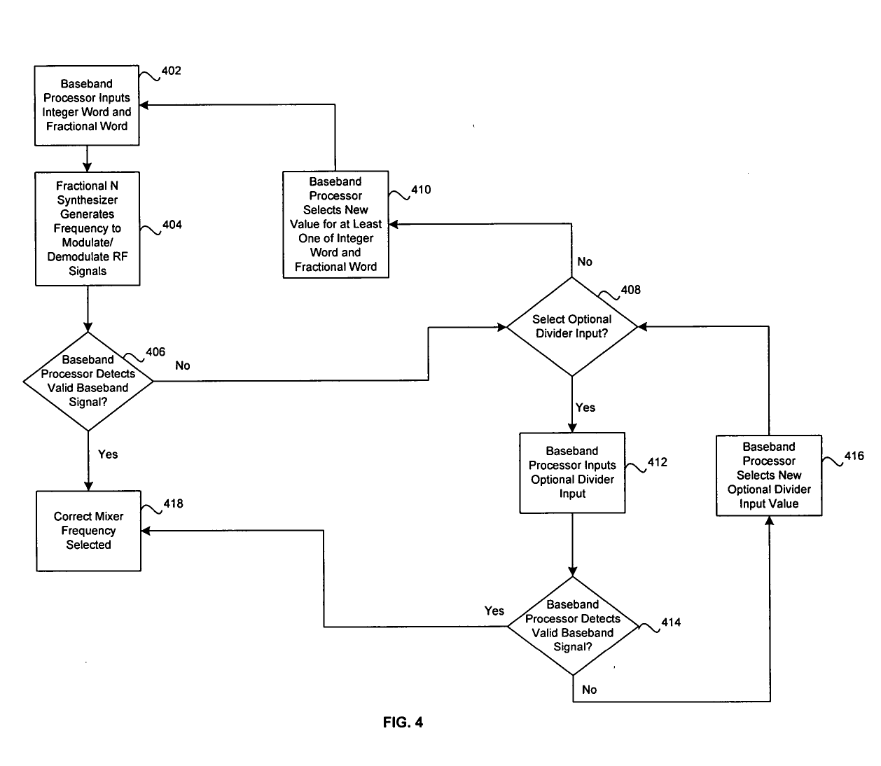

FIG. 4 is an exemplary flow diagram illustrating the operation of the fractional N synthesizer for European, World, and US wireless bands, in accordance with an embodiment of the invention. Referring to FIG. 4, in step 402 the baseband processor inputs integer word and fractional word data to the fractional N synthesizer. In step 404, the fractional N synthesizer generates a frequency to modulate and demodulate RF signals. In step 406, the baseband processor determines it is receiving a valid baseband signal. If so, then in step 416 the correct frequency has been selected. If the baseband processor does not determine in step 406 that a valid baseband signal has been received, in step 408, the baseband processor determines whether to select the optional divider input. If the optional divider input is not to be utilized, in step 410, a new value is selected for at least one of the integer word and the fractional word.

If an optional data word is to be utilized at step 408, then at step 412 the baseband processor inputs the optional data word. In step 414, the baseband processor determines if a valid baseband signal has been detected. If, in step 414, the baseband processor determines that the baseband signal is valid, the next step is 418. If, at step 414, the baseband processor determines that the baseband signal is not valid, then at step 416, the baseband processor selects a new value for the optional divider input. Step 408 is the following step where the baseband processor determines whether to select the optional divider input.

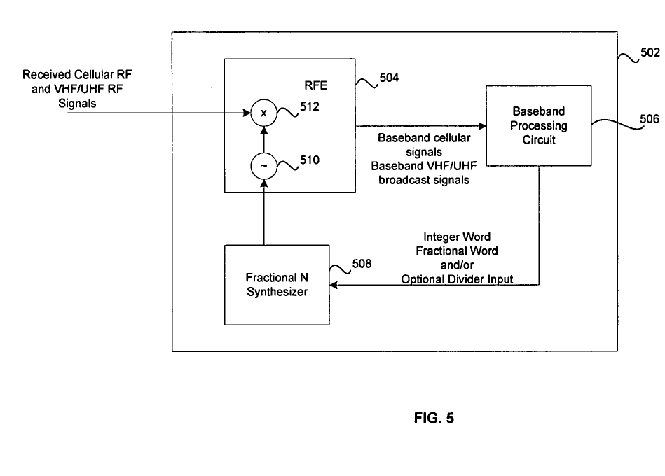

FIG. 5 is a block diagram of a mobile terminal that may be utilized in accordance with an embodiment of the invention. Referring to FIG. 5, there is shown a mobile terminal 502, a receiver front end (RFE) circuit 504, a baseband processing circuit 506, a fractional N synthesizer 508, an oscillator 510 and a mixer 512. The oscillator 510 is coupled to the mixer 512. The fractional N synthesizer 508 coupled to the mixer 512. Also illustrated in FIG. 5 are received cellular RF signals and received VHF/UHF broadcast signals.

The mixer 512 is adapted to mix, within the mobile terminal 502, the received cellular RF signals and received VHF/UHF broadcast RF signals with an output generated by the oscillator. The mixer may be adapted to generate baseband cellular signals corresponding to the received cellular RF signals and also generate baseband VHF/UHF broadcast signals corresponding to the received VHF/UHF broadcast RF signals. The baseband cellular signals and the baseband VHF/UHF broadcast signals may be communicated to the baseband processor 504 for processing.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communicating information via a plurality of different networks, the method comprising controlling, in a mobile terminal that receives and processes cellular RF signals and VHF/UHF broadcast RF signals, an oscillator utilized for mixing via a fractional N synthesizer.

2. The method according to claim 1, further comprising converting, in said mobile terminal, said received cellular RF signals and VHF/UHF broadcast RF signals, to corresponding baseband cellular signals and baseband VHF/UHF broadcast signals.

3. The method according to claim 1, further comprising generating, in said mobile terminal, at least one control signal from at least one baseband processing circuit that converts said cellular RF signals and received VHF/UHF broadcast RF signals to corresponding baseband cellular signals and baseband VHF/UHF broadcast signals.

4. The method according to claim 3, wherein said at least one control signal comprises a fractional word and an integer word.

5. The method according to claim 1, further comprising controlling said fractional N synthesizer via at least one external divider input signal.

6. The method according to claim 1, further comprising generating, in said mobile terminal, a quadrature output timing signal and a corresponding in-phase output timing signal that controls a first oscillator that is utilized to convert said received cellular RF signals and VHF/UHF broadcast RF signals, to corresponding baseband cellular signals and baseband VHF/UHF broadcast signals.

7. The method according to claim 6, further comprising:
generating, within said mobile terminal, at least one output signal from said first oscillator; and
mixing, within said mobile terminal, said generated at least one output signal with said received cellular RF signals and VHF/UHF broadcast RF signals.

8. The method according to claim 1, further comprising receiving, in said mobile terminal, a reference signal from a second oscillator as an input to said fractional N synthesizer.

9. The method according to claim 1, further comprising generating, within said mobile terminal, at least one filter control signal by said fractional N synthesizer that controls at least one external loop filter.

10. The method according to claim 1, wherein:
said received cellular RF signals comprises global system for mobile communications (GSM), general packet radio service (GPRS), enhanced data rates for GSM evolution (EDGE), code division multiple access 2000 (CDMA2000), wideband CDMA (WCDMA), high speed downlink packet access (HSDPA) systems, and multiple broadcast/multicast service (MBMS); and
said received VHF/UHF broadcast RF signals comprises ATSC, ISDB and a DVB.

11. A system for communicating information via a plurality of different networks, the system comprising circuitry in a mobile terminal that receives and processes cellular RF signals and VHF/UHF broadcast RF signals, that controls an oscillator utilized for mixing via a fractional N synthesizer.

12. The system according to claim 11, further comprising circuitry in said mobile terminal that converts said received cellular RF signals and VHF/UHF broadcast RF signals, to corresponding baseband cellular signals and baseband VHF/UHF broadcast signals.

13. The system according to claim 11, further comprising circuitry in said mobile terminal that generates at least one control signal from at least one baseband processing circuit that converts said cellular RF signals and received VHF/UHF broadcast RF signals to corresponding baseband cellular signals and baseband VHF/UHF broadcast signals.

14. The system according to claim 13, wherein said at least one control signal comprises a fractional word and an integer word.

15. The system according to claim 11, further comprising circuitry in said mobile terminal that controls said fractional N synthesizer via at least one external divider input signal.

16. The system according to claim 11, further comprising circuitry in said mobile terminal that generates a quadrature output timing signal and a corresponding in-phase output timing signal that controls a first oscillator that is utilized to convert said received cellular RF signals and VHF/UHF broadcast RF signals, to corresponding baseband cellular signals and baseband VHF/UHF broadcast signals.

17. The system according to claim 16, further comprising:
circuitry in said mobile terminal that generates at least one output signal from said first oscillator; and
circuitry in said mobile terminal that mixes said generated at least one output signal with said received cellular RF signals and VHF/UHF broadcast RF signals.

18. The system according to claim 11, further comprising circuitry in said mobile terminal that receives a reference signal from a second oscillator as an input to said fractional N synthesizer.

19. The system according to claim 11, further comprising circuitry in said mobile terminal that generates at least one filter control signal by said fractional N synthesizer that controls at least one external loop filter.

20. The system according to claim 11, wherein:
said received cellular RF signals comprises global system for mobile communications (GSM), general packet radio service (GPRS), enhanced data rates for GSM evolution (EDGE), code division multiple access 2000 (CDMA2000), wideband CDMA (WCDMA), high speed downlink packet access (HSDPA) systems, and multiple broadcast/multicast service (MBMS); and
said received VHF/UHF broadcast RF signals comprises ATSC, ISDB and a DVB.

21. A system for communicating information via a plurality of different networks, the system comprising:
a mobile terminal that comprises:
a mixer;
an oscillator coupled to said mixer; and
a fractional N synthesizer coupled to said mixer, wherein said mixer mixes, within said mobile terminal, received cellular RF signals and received VHF/UHF broadcast RF signals with an output of said oscillator.

22. The system according to claim 21, wherein said mixer generates baseband cellular signals corresponding to said received cellular RF signals.

23. The method according to claim 22, wherein said mixer generates baseband VHF/UHF broadcast signals to corresponding to said received VHF/UHF broadcast RF signals.
